(19) United States
(12) Patent Application Publication
(10) Pub. No.: US 2024/0135407 A1
(43) Pub. Date: Apr. 25, 2024

(54) INFORMATION PROCESSING DEVICE

(71) Applicant: NTT DOCOMO, INC., Chiyoda-ku (JP)

(72) Inventors: Kunihiro AIBA, Chiyoda-ku (JP); Souhei ONO, Chiyoda-ku (JP)

(73) Assignee: NTT DOCOMO, INC., Chiyoda-ku (JP)

(21) Appl. No.: 18/262,831

(22) PCT Filed: Dec. 7, 2021
(86) PCT No.: PCT/JP2021/044986

§ 371 Date: Jul. 25, 2023

(30) Foreign Application Priority Data
Jan. 29, 2021 (JP) 2021-013162

(51) Int. Cl. G06Q 30/0207; G06F 3/04817; G06F 3/0482; G06Q 30/0235

(52) U.S. Cl. CPC G06Q 30/0239; G06F 3/04817; G06F 3/0482; G06Q 30/0235

(57) ABSTRACT

The server 10 includes: a display control unit 14 that displays link image IM in top screen SC1; a first model generator 161 that generates a first model M1 configured to output, for each content, a first score related to a probability that the link image IM is selected by a user by machine learning based on information indicating whether link image IM is selected by a user, a user attribute of the user, and information indicating content displayed as link image IM; a user attribute acquisition unit 12 that acquires a user attribute of a target user; and an image determining unit 131 that preferentially determines an image of content having a high first score as an image associated with link image IM in top screen SC1 presented to the target user.

### TECHNICAL FIELD

One aspect of the present invention relates to an information processing device.

### BACKGROUND ART

In a content providing service for providing (selling) content such as a moving image or an electronic book to a user, a mechanism for presenting a screen for displaying a list of content recommended to the user to the user is known. For example, icons corresponding to the respective content are vertically and horizontally aligned and displayed in one screen. When the number of content to be recommended is large, icons corresponding to all the content may not be displayed in one screen. In such a case, a link image or the like for transitioning to another screen for displaying a list of content that did not fit within one screen (content that were not displayed on the first screen) may be used. By selecting the link image displayed on the first screen, the user can open another screen and access a list of content that were not displayed on the first screen. Such a link image may be associated with, for example, an image or the like indicating the details of the content (for example, see Patent Document 1).

### CITATION LIST

### Patent Document

[Patent Document 1] Japanese Unexamined Patent Publication No. 2018-180612

### SUMMARY OF INVENTION

### Technical Problem

In the content providing service as described above, it can be expected that a conversion rate (a rate at which a user uses or purchases content) is improved by bringing more content into contact with the user's eyes. For this reason, in the mechanism using the link image as described above, a structure for improving the probability (hereinafter referred to as a “selection probability”) that the user selects the link image is needed in order to bring more content into contact with the user's eyes.

An object of one aspect of the present invention is to provide an information processing device capable of improving a conversion rate by improving a selection probability of a link image.

### Solution to Problem

An information processing device according to one aspect of the present invention includes: a display control unit configured to display, in a first screen presented to a user, a list of some content among a plurality of content and a link image in which a link to a second screen on which a list of non-display content not displayed in the first screen is displayed and one or more images of the non-display content are associated with each other; a first model generator configured to generate a first model by machine learning based on information indicating whether the link image is selected by the user and information indicating content displayed as the link image, wherein the first model is configured to output, for each content, a first score corresponding to a user attribute related to a probability that the link image is selected by the user when an image of the content is associated with the link image; a user attribute acquisition unit configured to acquire a user attribute of a target user to which the first screen is presented; and an image determining unit configured to acquire the first score of each content by inputting the user attribute of the target user acquired by the user attribute acquisition unit into the first model, and preferentially determine an image of the content having a high first score as an image associated with the link image in the first screen presented to the target user.

In the information processing device according to one aspect of the present invention, when there are a plurality of content that cannot be displayed in one screen (first screen), a link image having a link function to a second screen for displaying non-display content that is not displayed in the first screen is displayed in the first screen. In addition, a first model that inputs the user attribute and outputs a first score related to the selection probability is generated. By preferentially associating an image of a content having a high first score obtained by such a first model with a link image, the selection probability of the link image can be improved. As a result, more content can be seen by the user, and the conversion rate can be improved.

### Advantageous Effects of Invention

According to one aspect of the present invention, it is possible to provide an information processing device capable of improving a conversion rate by improving a selection probability of a link image.

### BRIEF DESCRIPTION OF DRAWINGS

FIG. 1 is a diagram illustrating an overall configuration of a server according to an embodiment.

FIG. 2 is a diagram illustrating an example of a top screen and a genre detail screen.

FIG. 3 is a diagram illustrating an example of a link image generation process.

FIG. 4 is a flowchart illustrating an example of the operation of the server.

FIG. 5 is a diagram illustrating an example of a hardware configuration of the server.

### DESCRIPTION OF EMBODIMENTS

Hereinafter, an embodiment of the present invention will be described in detail with reference to the accompanying drawings. In the description of the drawings, the same or corresponding elements will be denoted by the same reference signs, and redundant description will be omitted.

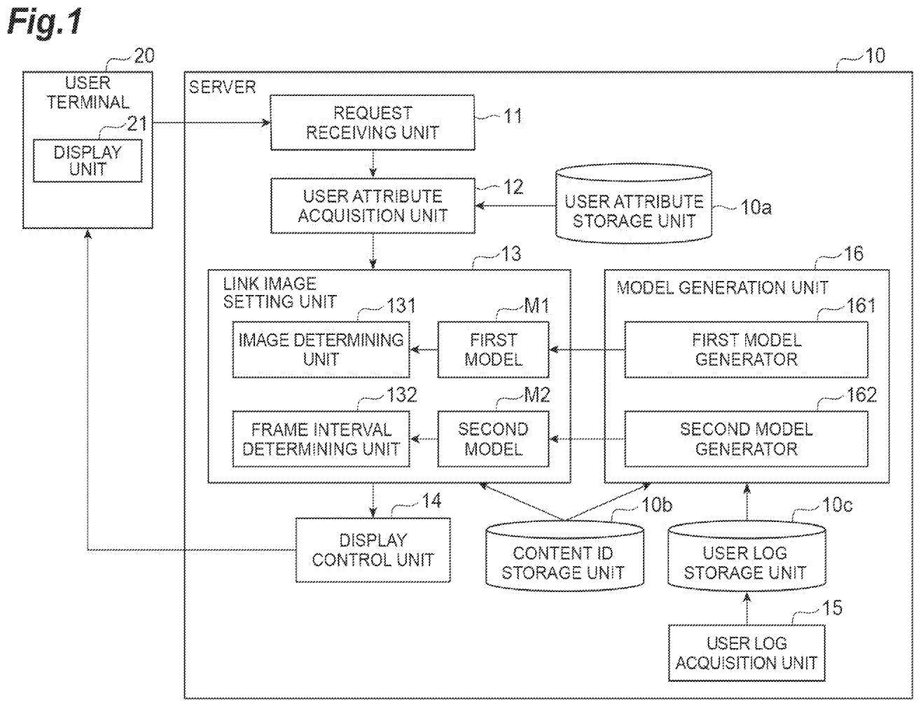

FIG. 1 is a diagram illustrating an overall configuration of a server 10 according to an embodiment. The server 10 is an information processing device for supporting a recommendation system that provides a conventionally known recommendation service. The recommendation service is a service for presenting a list of content to be recommended to a user in a content providing service for providing (selling) content such as moving images and books to the user. The server 10 may be a system different from the recommendation system or may also serve as the recommendation system.

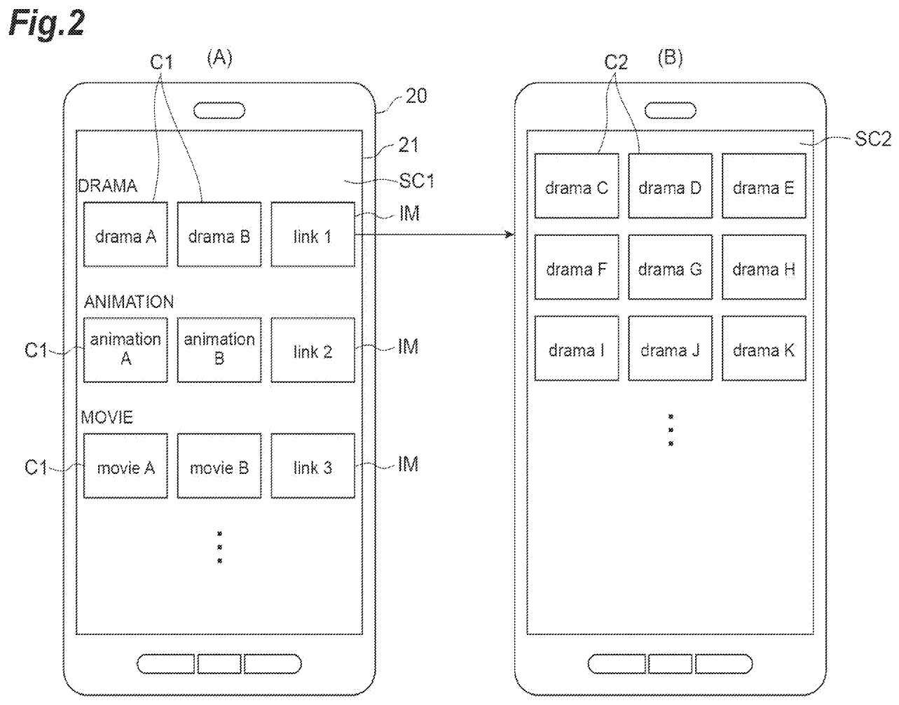

For example, as illustrated in (A) of FIG. 2, when a user accesses the content providing service by operating a user terminal 20, a top screen SC1 (first screen) of the content providing service is displayed on a display unit 21 of the user terminal 20. In the top screen SC1, a list of content C1 recommended to the user is displayed. In the present embodiment, the user terminal 20 is a smartphone including a touch panel display as the display unit 21. However, the user terminal 20 is not limited to the above-described form and may be a terminal including the display unit 21, and may be, for example, a tablet terminal, a desktop PC, a laptop PC, or the like.

In the present embodiment, a content C1 to be recommended is displayed for each content genre. In the example of FIG. 2, two content C1 belonging to the genre “drama” (“drama A” and “drama B”), two content C1 belonging to the genre “animation” (“animation A” and “animation B”), and two content C1 belonging to the genre “movie” (“movie A” and “movie B”) are displayed in the top screen SC1. As an example, each content C1 displayed on the top screen SC1 has a form of a rectangular icon associated with an image of each content C1. The image of the content is an image indicating details of the content (for example, a title screen of a moving image content, a screen representing a cover of a book content, or the like).

The user can use (for example, view, purchase, or the like) the content C1 by performing an operation (for example, a touch operation, a click operation, or the like) of selecting an icon of the content C1 of interest.

In each genre, the content to be recommended to the user may exist in other than the content C1 displayed in the top screen SC1. However, since there is a limit to the size of the display area of the display unit 21 of the user terminal 20, it may not be possible to display all content to be recommended in the top screen SC1. That is, in the example of FIG. 2, in the top screen SC1, only the content C1 in which the ranks of the degrees of recommendation to the user are the first place and the second place in each genre are displayed, and the content in which the rank is the third place or lower is not displayed. Therefore, link image IM associated with a link to a genre detail screen SC2 (second screen) for each genre is displayed on the top screen SC1. On the genre detail screen SC2, a list of content C2 (non-display content) that could not be displayed on the top screen SC1 is displayed. One or more images of the content C2 are associated with the link image IM. Note that the recommendation degree described above can be calculated by the recommendation system using a known recommendation mechanism.

As illustrated in (B) of FIG. 2, for example, when the link image IM (“link 1”) of the genre “drama” is selected, the top screen SC1 transitions to the genre detail screen SC2 on which a list of content C2 (“drama C” to “drama K” and the like in the example of FIG. 2) not displayed on the top screen SC1 among the recommendation target content belonging to the genre “drama” is displayed. The same applies to a case where link image IM of another genre (“link 2” or “link 3”) is selected. Note that in the example of (B) of FIG. 2, the content list displayed on the genre detail screen SC2 does not include the content C1 displayed on the top screen SC1, but the content C1 displayed on the top screen SC1 may be displayed on the genre detail screen SC2 together with the content C2 that was not displayed on the top screen SC1.

In the content providing service, it can be expected to improve the conversion rate by exposing more content to the eyes of the user. For this purpose, it is effective to improve the selection probability of the link image IM (that is, the probability that the user can be guided to the genre detail screen SC2). Therefore, the server 10 is configured to execute a process of personalizing the link image IM in accordance with the attribute of the user in order to improve the selection probability of the link image IM. Hereinafter, the configuration of the server 10 will be described in detail.

As illustrated in FIG. 1, the server 10 includes a request receiving unit 11, a user attribute acquisition unit 12, a link image setting unit 13, a display control unit 14, a user log acquisition unit 15, and a model generation unit 16. In addition, the server 10 includes a user attribute storage unit 10a, a content ID (identifier) storage unit 10b, and a user log storage unit 10c as elements that store various types of data.

The request receiving unit 11 receives an access request to a content providing service from a user (a user terminal 20). More specifically, the request receiving unit 11 receives an information request for the top screen SC1 of the content providing service from the user terminal 20.

The user attribute acquisition unit 12 acquires a user attribute of a target user to which a top screen SC1 is presented. In the present embodiment, the user attribute storage unit 10a stores a user attribute for each user in advance. As an example, the user attribute storage unit 10a stores user attributes (in this embodiment, a user attribute vector z described later) associated with user IDs for uniquely identifying users. The user attribute acquisition unit 12 acquires a user attribute vector z corresponding to the user ID of the target user from the user attribute storage unit 10a. Here, the target user is a user of the user terminal 20 that is a transmission source of the information request received by the request receiving unit 11. For example, the user attribute acquisition unit 12 specifies the user ID of the target user on the basis of information for identifying the user included in the information request (for example, a terminal ID associated with the user ID).

The user attribute is information related to a feature (attribute) of the user. The user attribute may include, for example, profile information such as the user's age (or generation), gender, address, etc. The user attribute may include information related to the hobby and preference of the user estimated from, for example, a questionnaire or the above-described profile information. The information related to the hobby and preference of the user is, for example, a preference degree for each genre of the content (for example, an index that takes a larger value as the preference of the user is higher).

In the user attribute storage unit 10a, a user attribute vector z obtained by digitizing and vectorizing various items as described above is stored for each of the user IDs. The user attribute vector z is generated, for example, as follows. As an example, a case where the user attribute vector z is expressed as one-dimensional vector (age, gender, address, . . . ) including items of age, gender, and address is considered. In this case, by appropriately labeling (digitizing) each item on the basis of a predetermined rule (for example, that male is set to “β” and female is set to “1” for gender), a numerical vector such as (0.4, 1.0, 0.7, . . . ) is obtained as a user attribute vector z of a user having a user attribute such as (40's, female, Kyushu, . . . ).

The link image setting unit 13 sets a link image IM personalized for the target user based on the user attribute vector z of the target user acquired by the user attribute acquisition unit 12. The link image setting unit 13 includes an image determining unit 131 and a frame interval determining unit 132. The link image setting unit 13 includes a first model M1 used for the processing of the image determining unit 131 and a second model M2 used for the processing of the frame interval determining unit 132.

The image determining unit 131 determines which content C2 image is to be displayed in the link image IM presented to the target user. To this end, the image determining unit 131 inputs a user attribute vector z of the target user to the first model M1 to obtain a first score for each content C2. For example, the image determining unit 131 acquires the content IDs of all the content C2 not displayed in the top screen SC1 by referring to the content ID storage unit 10b that stores content IDs for uniquely specifying each content, and acquires the first scores corresponding to the respective content IDs.

The first model M1 is generated (updated) by a first model generator 161 to be described later. More specifically, the first model M1 is a model obtained by executing reinforcement learning in which a reward is given to a content when a link image IM is selected by a user in a situation where an image of the content is displayed as a link image IM. As an example, the first model M1 is obtained by using a bandit algorithm (for example, a contextual bandit algorithm such as LinUCB) which is a kind of reinforcement learning algorithm. For example, the first model M1 can be expressed by the following Expression 1. The first model M1 includes parameters (θₐ and Aₐ) for each content a. The parameters θ₈ and A₈ are parameters that are appropriately updated by reinforcement learning. Details of these parameters (initial values and update methods) will be described later.

S_contₐ=θₐ^{T}z+αz^{T}Aₐ⁻¹z (Expression 1)

In Expression 1, “a” is an identifier indicating a content ID. “S_contₐ” indicates the first score of the content a (content corresponding to the content ID “a”). “z” indicates the above-described user attribute vector. “θₐ” is a unit vector of the same dimension as the user attribute vector z. When the image of the content a is displayed as the link image IM, θₐ is learned (updated) such that “θₐ^{T}z” increases as the probability that the user (user having the user attribute vector z) selects the link image IM increases. “θₐ^{T}z” is a term (utilization term) contributing to “utilization” in the bandit algorithm.

The second term of Expression 1 is a term (search term) contributing to “search” in the bandit algorithm. “α” is a weight of the search term and is arbitrarily determined. By adjusting the magnitude of α, the ratio between utilization and search can be adjusted.

The image determining unit 131 calculates the first score for each content C2 based on the user attribute vector z and the first model M1 corresponding to each content C2 (that is, (Expression 1) corresponding to each content C2).

Subsequently, the image determining unit 131 preferentially determines an image of the content C2 having a high first score as an image associated with the link image IM in the top screen SC1 presented to the target user. In the present embodiment, the image determining unit 131 determines an image associated with a link image IM for each genre. In addition, the image determining unit 131 determines each image of the plurality of (N) content C2 as images associated with the link image IM. N is a preset value equal to or greater than 2. More specifically, the image determining unit 131 ranks the plurality of content C2 in descending order of the first score for each genre, and determines an image of each of the content C2 from the first to the N-th place as images associated with the link image IM.

In the present embodiment, the link image IM is configured as a GIF image (animation image) in which each image of the N pieces of content C2 determined by the image determining unit 131 is sequentially switched at a constant frame interval. The frame interval determining unit 132 determines a frame interval to be applied to the link image IM presented to the target user. To this end, the frame interval determining unit 132 inputs a user attribute vector z of a target user to a second model M2 to obtain a second score for each frame interval.

The second model M2 is generated (or updated) by a second model generator 162 described later. More specifically, the second model M2 is a model obtained by executing reinforcement learning in which a reward is given to a certain frame interval when the link image IM is selected by the user in a situation where the frame interval is applied to the link image IM. As an example, like the first model M1, the second model M2 is obtained by using a bandit algorithm (for example, a contextual bandit algorithm such as LinUCB) which is a kind of reinforcement learning algorithm. For example, the second model M2 can be expressed by the following Expression 2. The second model M2 includes parameters (ρₜ and Bₜ) for each candidate of a predetermined frame interval length t (for example, 0.5 seconds, 0.8 seconds, 1 second, 1.5 seconds, 2 seconds, 2.5 seconds, 3 seconds, or the like). The parameters ρₜ and Bₜ are parameters that are appropriately updated by reinforcement learning. Details of these parameters (initial values and update methods) will be described later.

S_intₜ=ρₜ^{T}z+βz^{T}Bₜ⁻¹z (Expression 2)

In Expression 2, “t” is an identifier indicating a candidate for the length of the frame interval. “S_intₜ” indicates the second score of the length t of the frame interval. “z” indicates the above-described user attribute vector. “pt” is a unit vector of the same dimension as the user attribute vector z. When the length t of the frame interval is applied to the link image IM, pt is learned (updated) so that “ρₜ^{T}z” increases as the probability that the user (user having the user attribute vector z) selects the link image IM increases. “ρₜ^{T}z” is a term (utilization term) contributing to “utilization” in the bandit algorithm.

The second term of Expression 2 is a term (search term) contributing to “search” in the bandit algorithm. “β” is a weight of the search term and is arbitrarily determined. By adjusting the magnitude of β, the ratio between utilization and search can be adjusted.

The frame interval determining unit 132 calculates the second score for each candidate of the frame interval length based on the user attribute vector z and the second model M2 corresponding to each candidate of the frame interval length (that is, Expression 2 corresponding to each candidate of the frame interval length).

Subsequently, the frame interval determining unit 132 preferentially determines a frame interval having a high second score as a frame interval to be applied to the link image IM in the top screen SC1 presented to the target user. For example, the frame interval determining unit 132 may determine a frame interval having a maximum second score as a frame interval to be applied to the link image IM.

As shown in FIG. 2, the display control unit 14 displays a list of some content C1 among the plurality of content and link image IM in the top screen SC1 presented to the target user. In the link image IM, a link to the genre detail screen SC2 on which a list of content C2 not displayed in the top screen SC1 is displayed and an image of one or more content C2 (that is, content C2 determined by the image determining unit 131) are associated.

The display control unit 14 displays a list of some content C1 associated with each of a plurality of genres (drama, animation, and movies in the example of FIG. 2) related to content, and link image IM (link 1, link 2, and link 3 in the example of FIG. 2) for each genre in the top screen SC1.

Further, the display control unit 14 changes the image displayed as the link image IM in accordance with the elapse of time. More specifically, the display control unit 14 changes the image displayed as the link image IM at a constant frame interval (that is, the frame interval determined by the frame interval determining unit 132). For example, the display control unit 14 displays, in the top screen SC1 presented to the target user, link image IM configured such that the images of the content C2 from the first place to the N-th place in descending order of first score are switched at a constant frame interval.

For example, when the frame interval applied to the link image IM is one second, in the link image IM, the image of the content C2 in the first place is displayed first, the image of the content C2 in the second place is displayed one second later, the image of the content C2 in the third place is displayed two seconds later, and the image of the content C2 in the N-th place is displayed N−1 seconds later. After the image of the N-th content C2 is displayed as the link image IM, the image of the content C2 in the first place is displayed as the link image IM again. In this manner, the images of the first to N-th content C2 are displayed in a loop in the link image IM.

The display control unit 14 transmits the data for displaying the link image IM to the user terminal 20 of the target user to display the link image IM as described above in the top screen SC1 displayed on the display unit 21 of the user terminal 20.

The display control unit 14 may generate a GIF image in which the images of the content C2 from the first place to the N-th place are switched in this order at a constant frame interval, and transmit the data of the GIF image to the user terminal 20 as the data for displaying the link image IM. However, since it takes some time to generate the GIF image, a time lag may occur from when the top screen SC1 (portion other than the link image IM) is displayed on the user terminal 20 to when the link image IM is appropriately displayed. In order to eliminate such a time lag, the display control unit 14 may perform the following processing.

The display control unit 14 may first transmit, to the user terminal 20, an image to be displayed first as a link image IM among images of each of the plurality of content C2 (first to N-th content) determined by the image determining unit 131. Thereafter, the display control unit 14 may transmit, to the user terminal 20, a GIF image (animation image) configured such that an image of each of the plurality of content C2 (first to N-th content) changes over time. The images of the respective content are stored in the server 10 (for example, in the content ID storage unit 10b) in association with the content IDs, for example. In this case, the display control unit 14 can acquire an image of each content C2 based on the content IDs of the first to N-th content C2 determined by the image determining unit 131.

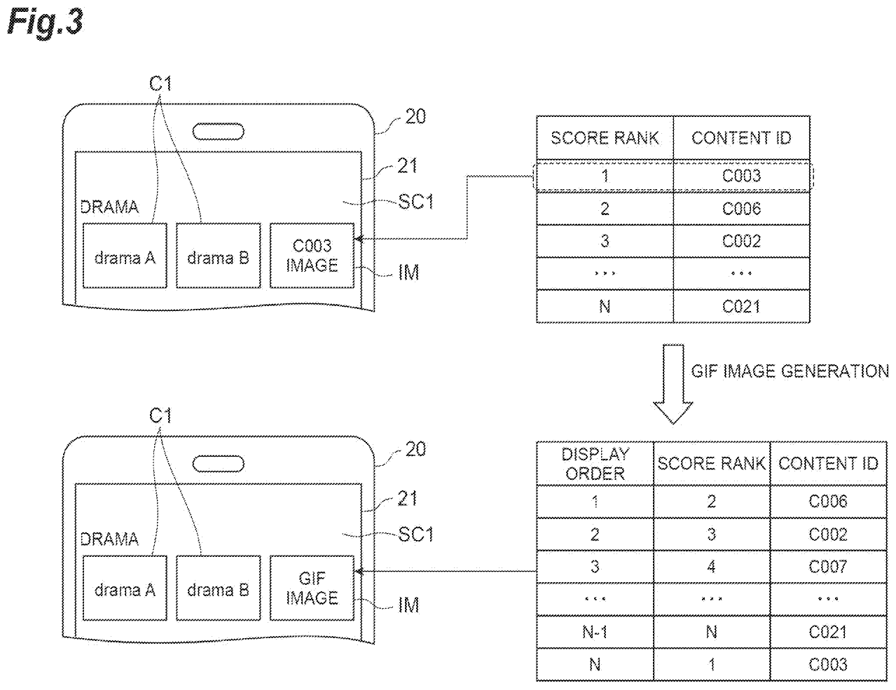

The processing of the display control unit 14 described above will be specifically described with reference to FIG. 3. In the example of FIG. 3, the image determining unit 131 determines the content C003 (the content of the content identifier “C003”. The same applies to the following), the content C006, the content C002, . . . , and the content C021 are determined as the first to N-th content C2. In this case, the display control unit 14 first displays an image (hereinafter referred to as “C003 image”) corresponding to the content C003 to be displayed in the link image IM. In this case, only the data of the user terminal 20 may be transmitted to the user terminal 20. Then, the display control unit 14 may instruct the user terminal 20 to generate and present the link image IM in which the C003 image is displayed. Then, the display control unit 14 may generate the GIF image after transmitting the C003 image to the user terminal 20 (or concurrently with the transmission process). For example, the display control unit 14 generates a GIF image in which images are switched in the order of “second place→third place→ . . . →N-th place→first place” in the frame interval determined by the frame interval determining unit 132 based on the list of content C2 from first place to the N-th place determined by the image determining unit 131. Then, the display control unit 14 may transmit the data of the generated GIF image to the user terminal 20. In this case, the display control unit 14 may transmit the frame interval together to the user terminal 20. Then, the display control unit 14 may instruct the user terminal 20 to change the image displayed as the link image IM from the C003 image to the GIF image when the frame interval notified from the display of the C003 image has elapsed. By the above-described processing, it is possible to suppress the occurrence of a time lag from when the user accesses the top screen SC1 to when the link image IM is displayed, and to smoothly draw the link image IM.

The user log acquisition unit 15 acquires a user log indicating an action result of the user in the content providing service. The user log includes information indicating whether a user who has accessed the top screen SC1 of the content providing service has selected link image IM, user ID of the user, information indicating content C2 displayed as link image IM (content ID in this embodiment), and length of frame interval applied to the link image IM. The user log corresponding to the case where the link image IM is selected also includes specific information for specifying the content C2 displayed as the link image IM when the link image IM is selected. In the present embodiment, as an example, the specific information is information indicating a time from when the link image IM is displayed (that is, from when the top screen SC1 is displayed) to when the link image IM is selected (that is, a stay time during which the user stays in the top screen SC1). User logs for a predetermined period relating to a plurality of users acquired by the user log acquisition unit 15 are stored in the user log storage unit 10c.

The model generation unit 16 generates the first model M1 and the second model M2 described above based on the user log indicating the action result of the user with respect to the setting content of the link image IM by the link image setting unit 13. In the present embodiment, the model generation unit 16 can acquire a user log necessary for generating the first model M1 and the second model M2 by referring to the user log storage unit 10c. The user log acquisition unit 15 may timely acquire a user log every time the content providing service is used by the user, and store the user log in the user log storage unit 10c. Then, the model generation unit 16 may update the first model M1 and the second model M2 using the newly obtained user log every time a new user log is stored in the user log storage unit 10c (or every predetermined period). According to such a process, the first model M1 and the second model M2 can be appropriately updated at any time.

The model generation unit 16 includes a first model generator 161 that generates the first model M1 and a second model generator 162 that generates the second model M2.

As described above, the first model M1 (see Expression 1) is configured to output, for each content a, the first score related to the probability that the link image IM is selected by the user when the image of the content a is associated with the link image IM (that is, when the image indicating the content a is displayed to the user as the link image IM) by inputting the user attribute. The first model generator 161 generates such a first model M1 by machine learning using information obtained from the above-described user log. More specifically, the first model generator 161 generates the first model M1 by machine learning based on information indicating whether or not the link image IM has been selected by the user, the user attribute corresponding to the user ID of the user (in the present embodiment, the user attribute vector z corresponding to the user ID stored in the user attribute storage unit 10a), and information indicating the content C2 displayed as the link image IM.

As described above, in the present embodiment, the first model M1 includes the parameter θₐ for each content a (see Expression 1). The first model generator 161 assigns the reward value rₐ to the content a displayed as the link image IM when the link image IM is selected by the user, and updates the parameter θₐ corresponding to the content a based on the reward value rₐ and the user attribute vector z of the user. According to such reinforcement learning, it is possible to generate a model capable of deriving an indicator (first score “S_contₐ”) for determining content (content to be associated with link image IM) suitable for guiding the user to the genre detail screen SC2 in a situation where there is no correct data on how to set link image IM to prompt the user to select link image IM.

A method of updating parameters by the reinforcement learning will be described in detail. Here, an update method using the above-described LinUCB algorithm will be described as an example. First, the first model generator 161 sets parameters θₐ and Aₐ for each content a shown in Expression 1 based on Expression 3 to Expression 5 below.

bₐ←0_{d×1} (Expression 3)

Aₐ←I_{d} (Expression 4)

θₐ←Aₐ⁻¹bₐ (Expression 5)

The parameter bₐ is a parameter included in the parameter θₐ. Expression 3 represents an initial value of the parameter bₐ. “0_{d×1}” in Expression 3 is a zero vector of the same dimension (d) as the user attribute vector z. Expression 4 represents an initial value of the parameter Aₐ. “I_{d}” in Expression 4 is a d-dimensional unit matrix. The parameter θₐ is calculated based on Expression 5. As shown in Expression 3 to Expression 5, the initial value of the parameter θₐ is a zero vector.

The first model generator 161 updates (learns) the parameters Aₐ and bₐ of the corresponding content a by the following Expression 6 and Expression 7 for each action of the user (that is, for one user log).

Aₐ←Aₐ+zz^{T} (Expression 6)

bₐ←bₐ+rₐz (Expression 7)

According to Expression 6, information indicating that “the user having the user attribute vector z has viewed the link image IM associated with the image of the content a (including a case where the link image IM is not selected)” is added to the parameter Aₐ. In addition, the information is reflected in the parameter θₐ by Expression 5.

According to Expression 7, the parameter bₐ is updated based on the reward value rₐ and the user attribute vector z of the user. Here, “update” includes a case where the value does not change before and after the update process. By updating the parameter bₐ, the parameter θₐ is also updated based on the reward value rₐ and the user attribute vector z of the user (see Expression 5).

Here, when the link image IM associated with the image of the content a is selected by the user having the user attribute vector z, the first model generator 161 gives a larger reward value rₐ than when the link image IM is not selected by the user. As an example, when the link image IM associated with the image of the content a is selected, the first model generator 161 sets the reward value rₐ of the content a to a value greater than 0. On the other hand, when the link image IM associated with the image of the content a is not selected, the first model generator 161 sets the reward value rₐ of the content a to 0. In other words, when the link image IM associated with the image of the content a is not selected, the first model generator 161 does not give a reward to the content a.

By the processing of the first model generator 161 described above, θₐ is learned (updated) such that the utilization term “θₐ^{T}Z” in Expression 1 becomes larger as the probability that the user (user having the user attribute vector z) selects the link image IM is higher when the image of the content a is displayed as the link image IM.

Here, in the present embodiment, as described above, the link image IM is associated with images of a plurality of content C2, and the image displayed as the link image IM changes overtime. In such a case, it is considered that the image of the content C2 displayed at the time when the user selects the link image IM most contributed to the inducement of the action of the user (that is, the selection of the link image IM). On the other hand, it is considered that the image of one or more content C2 displayed as link image IM from when the link image IM is presented to the user to when the user selects the link image IM also contributes to the inducement of the action of the user. More specifically, it is considered that the content C2 displayed as the link image IM at a time point closer to the time point at which the link image IM is selected by the user has a larger degree of contribution to the inducement of the action of the user. Based on the above, the first model generator 161 may assign a larger reward value rₐ to each of the content displayed as the link image IM at the time point when the link image IM is selected and the content displayed as the link image IM before the time point when the link image IM is selected than the case where the link image IM is not selected by the user. Then, the reward value rₐ may be set to a larger value for content displayed as the link image IM at a time point closer to the time point when the link image IM is selected.

For example, the first model generator 161 may determine the reward value rₐ of each content a based on the following Expression 8).

$$\\ \begin{matrix}{r}_{a} = \{ \begin{matrix}{e}^{k - mod ( i , L )} & ( k \leq mod ( i , L ) ) \\ 0 & ( mod ( i , L ) < k , i \leq L ) \\ {e}^{k - mod ( i , L ) - L} & ( mod ( i , L ) < k , L \leq i )\end{matrix} i = round ( \frac{ST}{Tint} ) & ( Expression 8 )\end{matrix}$$

In Expression 8, “k” indicates the number (display order) of the content a displayed as the link image IM. The number k of the content a displayed n-th as link image IM is represented by “n−1”. “i” indicates the number of the content displayed as the link image IM when the link image IM is selected by the user. “L” indicates the total number of content associated with the link image IM (i.e., content included in the GIF image). “Tint” indicates the length of the frame interval applied to the link image IM. “ST” indicates a time during which the user stays in the top screen SC1 (that is, a time from when the top screen SC1 is displayed to when the link image IM is selected).

The first (upper) expression in Expression 8 is applied to content having a number smaller than the number of content displayed when the link image IM is selected. The second (middle) expression in Expression 8 is applied to content that has a number larger than the number of content displayed when the link image IM is selected and has never been displayed until the link image IM is selected. The third (lower) expression in Expression 8 is applied to content having a number larger than the number of content displayed when the link image IM is selected and displayed once or more until the link image IM is selected.

For example, a case will be considered in which “L=9” and the link image IM is selected when an image of content of “k=2” is displayed in the link image IM in the second round. In this case, the reward value rₐ of each content a is calculated as shown in Table 1 below by Expression 8 above.

TABLE 1

| k | 0 | 1 | 2 | 3 | 4 | 5 | 6 | 7 | 8 |
|---|---|---|---|---|---|---|---|---|---|
| rₐ | e⁻ [symbol] | e⁻ [symbol] | 1 (=e⁰) | e⁻ [symbol] | e⁻ [symbol] | e⁻ [symbol] | e⁻⁵ | e⁻⁴ | e⁻ [symbol] |

[symbol]

indicates data missing or illegible when filed

As described above, the maximum reward value rₐ is given to the content displayed as the link image IM when the link image IM is selected, and the reward value rₐ is given to the content viewed by the user until the link image IM is selected in such a manner that the reward rₐ increases in ascending order of distance from the time when the link image IM is selected. Accordingly, an appropriate reward according to the degree of contribution can be given to each content.

As described above, the second model M2 (see Expression 2) is configured to output the second score related to the probability that the link image IM is selected by the user when the user attribute is input and the length t of a certain frame interval is applied to the link image IM, for each length t of the frame interval (for each candidate of the predetermined length t). The second model generator 162 generates such a second model M2 by machine learning using information obtained from the above-described user log. More specifically, the second model generator 162 generates the second model M2 by machine learning based on information indicating whether or not the link image IM is selected by the user, a user attribute corresponding to the user ID of the user (in this embodiment, a user attribute vector z corresponding to the user ID stored in the user attribute storage unit 10a), and information indicating the frame interval applied to the link image IM.

As described above, in the present embodiment, the second model M2 includes the parameter pt for each length t of the frame interval (see Expression 2). The second model generator 162 assigns the reward value rₜ to the frame interval t applied to the link image IM when the link image IM is selected by the user, and updates the parameter pt corresponding to the length t of the frame interval based on the reward value rₜ and the user attribute vector z of the user. According to such reinforcement learning, it is possible to generate a model capable of deriving an indicator (second score “S_intₜ”) for determining a frame interval suitable for guiding the user to the genre detail screen SC2 in a situation where there is no correct data on how to set a link image IM to prompt the user to select the link image IM.

A method of updating parameters by the reinforcement learning will be described in detail. Here, an update method using the above-described LinUCB algorithm will be described as an example. First, the second model generator 162 sets parameters ρₜ and Bₜ for each length t of the frame interval shown in Expression2 based on Expression 9 to Expression 11 below.

cₜ←0_{d×1} (Equation 9)

Bₜ←I_{d} (Equation 10)

ρₜ←Bₜ⁻¹cₜ (Equation 11)

The parameter cₜ is a parameter included in the parameter pt. Expression 9 represents an initial value of the parameter cₜ. “0_{d×1}” in Expression 9 is a zero vector of the same dimension (d) as the user attribute vector z. Expression 10 represents an initial value of the parameter Bₜ. “I_{d}” in Expression 10 is a d-dimensional unit matrix. The parameter ρₜ is calculated based on Expression 11. As shown in Expression 9 to Expression 11, the initial value of the parameter ρₜ is a zero vector.

The second model generator 162 updates (learns) the parameters Bₜ and cₜ of the length t of the corresponding frame interval by the following Expression 12 and Expression 13 for each action of the user for one time (that is, for one user log).

Bₜ←Bₜ+zz^{T} (Expression 12)

bₜ←bₜ+rₜz (Expression 13)

According to Expression 12, information indicating that “the user having the user attribute vector z has viewed the link image IM to which the length t of the frame interval is applied (including a case where the link image IM is not selected)” is added to the parameter Bₜ. In addition, the information is reflected in the parameter ρₜ by Expression 11.

According to Expression 13, the parameter cₜ is updated based on the reward value rₜ and the user attribute vector z of the user. Here, “update” includes a case where the value does not change before and after the update process. By updating the parameter cₜ, the parameter ρₜ is also updated based on the reward value rₜ and the user attribute vector z of the user (see Expression 11)).

Here, when the link image IM to which the frame interval t is applied is selected by the user having the user attribute vector z, the second model generator 162 gives a larger reward value rₜ than when the link image IM is not selected by the user. As an example, when the link image IM to which the length t of the frame interval is applied is selected, the second model generator 162 may set the reward value rₜ of the length t to a value larger than 0 (e.g., “1”). On the other hand, when the link image IM to which the length t of the frame interval is applied is not selected, the second model generator 162 sets the reward value rₜ of the length t to 0. In other words, when the link image IM to which the length t of the frame interval is applied is not selected, the second model generator 162 does not give a reward to the length t.

By the processing of the second model generator 162 described above, ρₜ is learned (updated) such that the utilization term “ρₜ^{T}z” in Expression 2 becomes larger as the probability that the user (user having the user attribute vector z) selects the link image IM is higher when the length t of the frame interval is applied to the link image IM.

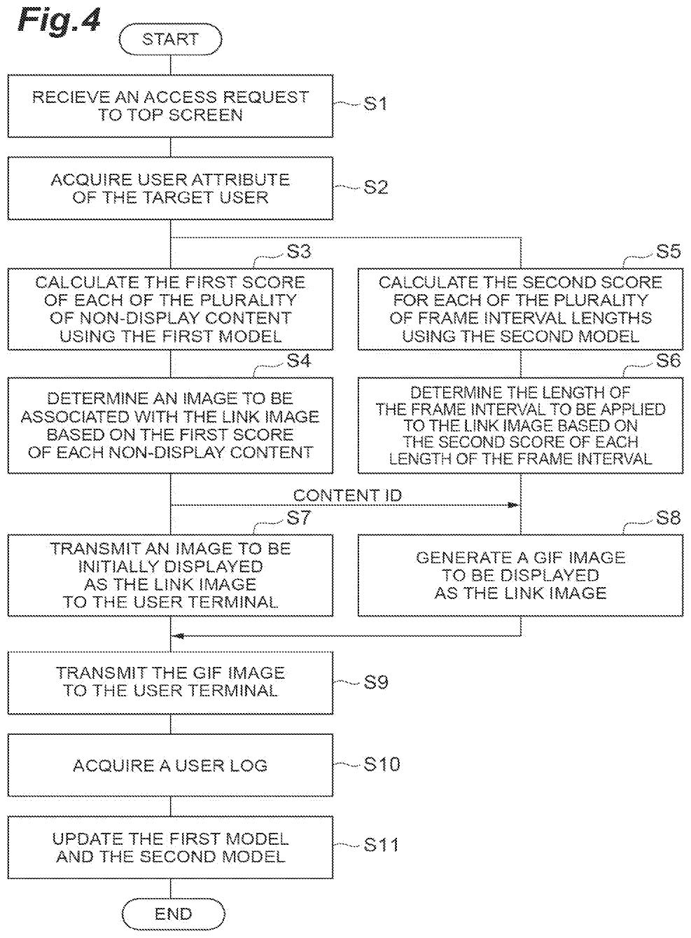

Next, an example of processing of the server 10 will be described with reference to a flowchart illustrated in FIG. 4.

First, the request receiving unit 11 receives an access request to the content providing service (top screen SC1) from the user terminal 20 (step S1). Subsequently, the user attribute acquisition unit 12 acquires a user attribute vector z of a user (target user) of the user terminal 20 which is a transmission source of the access request by referring to the user attribute storage unit 10a(step S2).

Subsequently, the link image setting unit 13 determines a plurality of content C2 associated with the link image IM and the length of the frame interval applied to the link image IM (steps S3 to S6).

Specifically, the image determining unit 131 inputs the user attribute vector z of the target user to the first model M1 (Expression 1 for each content a) to calculate the first score “S_contₐ” of each of the plurality of content C2 (non-display content that is not displayed in the top screen SC1) (step S3). The image determining unit 131 determines an image to be associated with the link image IM (that is, an image to be displayed as the link image IM) based on the first score “S_contₐ” of each content C2 (step S4). As an example, the image determining unit 131 determines N pieces of content C2 with first score “S_contₐ” up to the top N places as images to be associated with link image IM.

The frame interval determining unit 132 inputs the user attribute vector z of the target user to the second model M2 (Expression 2 for each length t of the frame interval) to calculate the second score “S_intₜ” for each of a plurality of frame interval lengths t (candidates) (step S5). Then, the frame interval determining unit 132 determines the length t of the frame interval to be applied to the link image IM based on the second score “S_intₜ” of each length t (step S6). As an example, the frame interval determining unit 132 may determine a length t having a maximum second score “S_intₜ” as a frame interval to be applied to the link image IM.

Subsequently, the display control unit 14 presents a top screen SC1 as illustrated in FIG. 2 to the user (steps S7 to S9). As an example, the display control unit 14 first transmits an image to be initially displayed as a link image IM (that is, an image of content C2 having a first score “S_contₐ” of first place) to the user terminal 20 (step S7). As a result, the link image IM in which the image is displayed is generated and presented in the user terminal 20. Further, after the processing of step S7 (or simultaneously in parallel with the processing of step S7), the display control unit 14 generates a GIF image based on information indicating the plurality of content C2 determined by the image determining unit 131 (content IDs of the content C2 of first place to the N-th place) and the frame interval determined by the frame interval determining unit 132 (step S8). The GIF image is an animation image configured such that images are switched in the order of “second place→third place→ . . . →Nth place→first place” at the frame interval. Subsequently, the display control unit 14 transmits the GIF image and information indicating the frame interval to the user terminal 20 (step S9). As a result, in the user terminal 20, the image (hereinafter referred to as “initial image”) transmitted to the user terminal 20 in step S7 is displayed. When the frame interval notified in step S9 elapses after the link image IM is displayed, the image displayed as the link image IM is changed from the initial image to the GIF image.

Subsequently, the user log acquisition unit 15 acquires a user log indicating an action result of the user in the content providing service (step S10). That is, the user log acquisition unit 15 acquires a user log which is result information (feedback information) indicating whether or not the user who has accessed the top screen SC1 selects the link image IM.

Subsequently, the model generation unit 16 (the first model generator 161 and the second model generator 162) updates the first model M1 and the second model M2 based on the user log acquired in step S10 (step S11).

In the server 10 described above, when there are a plurality of content that cannot be displayed in one screen (top screen SC1), the link image IM having a link function to the genre detail screen SC2 for displaying the content C2 that is not displayed in the top screen SC2 is displayed in the top screen SC1. In addition, the first model generator 161 generates a first model M1 that inputs a user attribute (user attribute vector z in the present embodiment) and outputs a first score “S_contₐ” related to the selection probability. By preferentially associating an image of a content having a high first score “S_contₐ” obtained by such a first model M1 with a link image IM, the selection probability of the link image IM can be improved. As a result, more content can be seen by the user, and the conversion rate can be improved.

The display control unit 14 also displays a list of some content C1 associated with each of the plurality of genres and link image IM for each genre in the top screen SC1 (see FIG. 2). Then, the image determining unit 131 determines an image associated with the link image IM for each genre. According to the above configuration, by displaying content related to each of a plurality of genres in the top screen SC1, it is possible to present content of various genres to the user. In addition, by preparing the link image IM as described above for each genre, more content for each genre can be seen by the user, and thus the conversion rate can be effectively improved.

In addition, the image determining unit 131 determines an image of each of the plurality of content C2 (in the present embodiment, N content C2 with the first score of first to N-th place) as an image associated with the link image IM. Then, the display control unit 14 changes the image displayed as the link image IM in accordance with the elapse of time. That is, the link image IM is configured as a GIF image (animation image). According to the above configuration, by changing the image displayed as the link image IM in accordance with the elapse of time, it is possible to cause a plurality of content C2 to come into contact with the user's eyes through the link image IM in the top screen SC1. It is possible to effectively improve the selection probability of the link image IM by sequentially displaying a plurality of content C2 that may attract the user's attention in the link image IM.

Further, the server 10 includes the second model generator 162 that generates the second model M2 and the frame interval determining unit 132 that determines a frame interval to be applied to the link image IM using the second model M2, and the display control unit 14 changes an image displayed as the link image IM at a constant frame interval determined by the frame interval determining unit 132. According to the above configuration, by applying an appropriate frame interval to the link image IM in accordance with the user attribute, it is possible to effectively improve the selection probability of the link image IM.

The above-described embodiment (that is, the configuration and the processing content of the server 10) may be appropriately modified. For example, there may be only one image of content associated with a link image IM. That is, the link image IM may not be configured such that the content to be displayed is switched at a constant frame interval. In other words, the link image IM may be constituted by only an image of one specific content. In this case, the frame interval determining unit 132, the second model M2, and the second model generator 162 may be omitted. Further, in this case, the image determining unit 131 may determine the image of the content having the largest first score “S_contₐ” as the image to be associated with the link image IM.

The machine learning algorithm executed by the first model generator 161 to generate the first model M1 is not limited to the LinUCB algorithm (bandit algorithm) described above. That is, the first model M1 may be configured to return a score similar to the above-described first score “S_contₐ” (that is, a score corresponding to the probability that the link image IM is selected by the user), and an algorithm different from the algorithm (parameter update expressions) described in the above-described embodiment may be used. For example, in the above-described embodiment, the LinUCB algorithm based on the so-called UCB-scheme among the bandit algorithms is used, but an algorithm of a scheme other than the above-described scheme (for example, an e-greedy scheme, a Thompson Sampling scheme, or the like) may be used. In addition, a reinforcement learning algorithm other than the bandit algorithm may be used. The same applies to the second model generator 162 and the second model M2.

The block diagrams used in the description of the embodiment show blocks in units of functions. These functional blocks (components) are realized in any combination of at least one of hardware and software. Further, a method of realizing each functional block is not particularly limited. That is, each functional block may be realized using one physically or logically coupled device, or may be realized by connecting two or more physically or logically separated devices directly or indirectly (for example, using a wired scheme, a wireless scheme, or the like) and using such a plurality of devices. The functional block may be realized by combining the one device or the plurality of devices with software.

The functions include judging, deciding, determining, calculating, computing, processing, deriving, investigating, searching, confirming, receiving, transmitting, outputting, accessing, resolving, selecting, choosing, establishing, comparing, assuming, expecting, regarding, broadcasting, notifying, communicating, forwarding, configuring, reconfiguring, allocating, mapping, assigning, or the like, but not limited thereto.

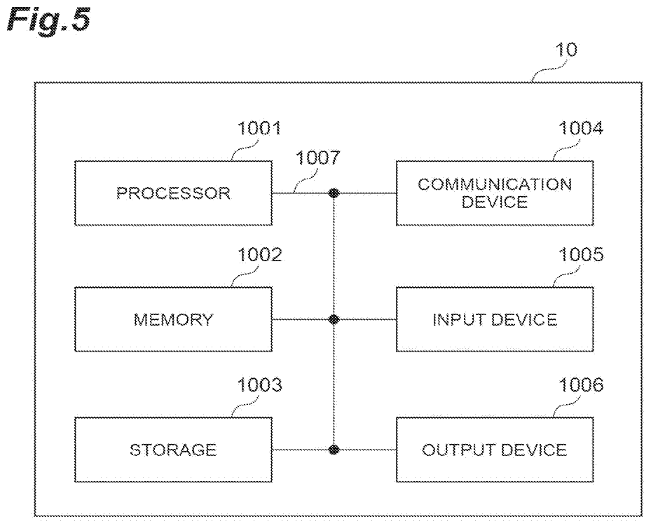

For example, the server 10 according to an embodiment of the present invention may function as a computer that performs an information processing method of the present disclosure. FIG. 5 is a diagram illustrating an example of a hardware configuration of the server 10 according to the embodiment of the present disclosure. The server 10 described above may be physically configured as a computer device including a processor 1001, a memory 1002, a storage 1003, a communication device 1004, an input device 1005, an output device 1006, a bus 1007, and the like.

In the following description, the term “device” can be referred to as a circuit, a device, a unit, or the like. The hardware configuration of the server 10 may include one or a plurality of devices illustrated in FIG. 5, or may be configured without including some of the devices.

Each function in the server 10 is realized by loading predetermined software (a program) into hardware such as the processor 1001 or the memory 1002 so that the processor 1001 performs computation to control communication that is performed by the communication device 1004 or control at least one of reading and writing of data in the memory 1002 and the storage 1003.

The processor 1001, for example, operates an operating system to control the entire computer. The processor 1001 may be configured as a central processing unit (CPU) including an interface with peripheral devices, a control device, a computation device, a register, and the like.

Further, the processor 1001 reads a program (program code), a software module, data, or the like from at one of the storage 1003 and the communication device 1004 into the memory 1002 and executes various processes according to the program, the software module, the data, or the like. As the program, a program for causing the computer to execute at least some of the operations described in the above-described embodiment may be used. For example, the link image setting unit 13 may be realized by a control program that is stored in the memory 1002 and operated on the processor 1001, and other functional blocks may be realized similarly. Although the case in which the various processes described above are executed by one processor 1001 has been described, the processes may be executed simultaneously or sequentially by two or more processors 1001. The processor 1001 may be realized using one or more chips. The program may be transmitted from a network via an electric communication line.

The memory 1002 is a computer-readable recording medium and may be configured of, for example, at least one of a read only memory (ROM), an erasable programmable ROM (EPROM), an electrically erasable programmable ROM (EEPROM), and a random access memory (RAM). The memory 1002 may be referred to as a register, a cache, a main memory (a main storage device), or the like. The memory 1002 can store an executable program (program code), software modules, and the like in order to implement the communication control method according to the embodiment of the present disclosure.

The storage 1003 is a computer-readable recording medium and may also be configured of, for example, at least one of an optical disc such as a compact disc ROM (CD-ROM), a hard disk drive, a flexible disc, a magneto-optical disc (for example, a compact disc, a digital versatile disc, or a Blu-ray (registered trademark) disc), a smart card, a flash memory (for example, a card, a stick, or a key drive), a floppy (registered trademark) disk, a magnetic strip, and the like. The storage 1003 may be referred to as an auxiliary storage device. The storage medium described above may be, for example, a database including at least one of the memory 1002 and the storage 1003, a server, or another appropriate medium.

The communication device 1004 is hardware (a transmission and reception device) for performing communication between computers via at least one of a wired network and a wireless network and is also referred to as a network device, a network controller, a network card, or a communication module, for example.

The input device 1005 is an input device (for example, a keyboard, a mouse, a microphone, a switch, a button, or a sensor) that receives an input from the outside. The output device 1006 is an output device (for example, a display, a speaker, or an LED lamp) that performs output to the outside. The input device 1005 and the output device 1006 may have an integrated configuration (for example, a touch panel).

Further, the respective devices such as the processor 1001 and the memory 1002 are connected by the bus 1007 for information communication. The bus 1007 may be configured using a single bus or may be configured using buses different between the devices.

Further, the server 10 may include hardware such as a microprocessor, a digital signal processor (DSP), an application specific integrated circuit (ASIC), a programmable logic device (PLD), or a field programmable gate array (FPGA), and some or all of the functional blocks may be realized by the hardware. For example, the processor 1001 may be implemented by at least one of these pieces of hardware.

Although the present embodiment has been described in detail above, it is apparent to those skilled in the art that the present embodiment is not limited to the embodiments described in the present disclosure. The present embodiment can be implemented as a modification and change aspect without departing from the spirit and scope of the present invention determined by description of the claims. Accordingly, the description of the present disclosure is intended for the purpose of illustration and does not have any restrictive meaning with respect to the present embodiment.

A process procedure, a sequence, a flowchart, and the like in each aspect/embodiment described in the present disclosure may be in a different order unless inconsistency arises. For example, for the method described in the present disclosure, elements of various steps are presented in an exemplified order, and the elements are not limited to the presented specific order.

Input or output information or the like may be stored in a specific place (for example, a memory) or may be managed in a management table. Information or the like to be input or output can be overwritten, updated, or additionally written. Output information or the like may be deleted. Input information or the like may be transmitted to another device.

A determination may be performed using a value (0 or 1) represented by one bit, may be performed using a Boolean value (true or false), or may be performed through a numerical value comparison (for example, comparison with a predetermined value).

Each aspect/embodiment described in the present disclosure may be used alone, may be used in combination, or may be used by being switched according to the execution. Further, a notification of predetermined information (for example, a notification of “being X”) is not limited to be made explicitly, and may be made implicitly (for example, a notification of the predetermined information is not made).

Software should be construed widely so that the software means an instruction, an instruction set, a code, a code segment, a program code, a program, a sub-program, a software module, an application, a software application, a software package, a routine, a sub-routine, an object, an executable file, a thread of execution, a procedure, a function, and the like regardless whether the software is called software, firmware, middleware, microcode, or hardware description language or called another name.

Further, software, instructions, information, and the like may be transmitted and received via a transmission medium. For example, when software is transmitted from a website, a server, or another remote source using wired technology (a coaxial cable, an optical fiber cable, a twisted pair, a digital subscriber line (DSL), or the like) and wireless technology (infrared rays, microwaves, or the like), at least one of the wired technology and the wireless technology is included in a definition of the transmission medium.

The information, signals, and the like described in the present disclosure may be represented using any of various different technologies. For example, data, an instruction, a command, information, a signal, a bit, a symbol, a chip, and the like that can be referred to throughout the above description may be represented by a voltage, a current, an electromagnetic wave, a magnetic field or a magnetic particle, an optical field or a photon, or an arbitrary combination of them.

Further, the information, parameters, and the like described in the present disclosure may be expressed using an absolute value, may be expressed using a relative value from a predetermined value, or may be expressed using another corresponding information.

Names used for the above-described parameters are not limited names in any way. Further, equations or the like using these parameters may be different from those explicitly disclosed in the present disclosure. Since various information elements can be identified by any suitable names, the various names assigned to these various information elements are not limited names in any way.

The description “based on” used in the present disclosure does not mean “based only on” unless otherwise noted. In other words, the description “based on” means both of “based only on” and “based at least on”.

Any reference to elements using designations such as “first,” “second,” or the like used in the present disclosure does not generally limit the quantity or order of those elements. These designations may be used in the present disclosure as a convenient way for distinguishing between two or more elements. Thus, the reference to the first and second elements does not mean that only two elements can be adopted there or that the first element has to precede the second element in some way.

When “include”, “including” and transformation of them are used in the present disclosure, these terms are intended to be comprehensive like the term “comprising”. Further, the term “or” used in the present disclosure is intended not to be exclusive OR.

In the present disclosure, for example, when articles such as “a”, “an”, and “the” in English are added by translation, the present disclosure may include that nouns following these articles are plural.

In the present disclosure, a sentence “A and B are different” may mean that “A and B are different from each other”. The sentence may mean that “each of A and B is different from C”. Terms such as “separate”, “coupled”, and the like may also be interpreted, similar to “different”.

### REFERENCE SIGNS LIST

10 server (information processing device)
11 Request receiving unit
12 user attribute acquisition unit
13 link image setting unit
14 display control unit
15 user log acquisition unit
16 model generation unit
20 user terminal
21 display unit
131 image determining unit
132 frame interval determining unit
161 First model generator
162 second model generator
C1 content
C2 content (non-display content)
IM link image
M1 first model
M2 second model
SC1 top screen (first screen)
SC2 genre detail screen (second screen).

1. An information processing device, comprising:
a display control unit configured to display, in a first screen presented to a user, a list of some content among a plurality of content and a link image in which a link to a second screen on which a list of non-display content not displayed in the first screen is displayed and one or more images of the non-display content are associated with each other;
a first model generator configured to generate a first model by machine learning based on information indicating whether the link image is selected by the user and information indicating content displayed as the link image, wherein the first model is configured to output, for each content, a first score corresponding to a user attribute related to a probability that the link image is selected by the user when an image of the content is associated with the link image;
a user attribute acquisition unit configured to acquire a user attribute of a target user to which the first screen is presented; and
an image determining unit configured to acquire the first score of each content by inputting the user attribute of the target user acquired by the user attribute acquisition unit into the first model, and preferentially determine an image of the content having a high first score as an image associated with the link image in the first screen presented to the target user.

2. The information processing device according to claim 1, wherein
the first model includes a parameter for each content, and
the first model generator is configured to:
assign a larger reward value to content displayed as the link image when the link image is selected by the user than in a case where the link image is not selected by the user; and
update the parameter corresponding to the content based on the reward value and a user attribute of the user.

3. The information processing device according to claim 1, wherein
the display control unit is configured to display a list of some content associated with each of a plurality of genres related to content and the link image for each genre in the first screen the image determining unit is configured to determine an image associated with the link image for each of the genres.

4. The information processing device according to claim 1, wherein
the image determining unit is configured to:
determine an image of each of the plurality of non-display content as an image associated with the link image; and
change an image displayed as the link image in accordance with the elapse of time.

5. The information processing device according to claim 4, wherein the display control unit is configured to change an image displayed as the link image at a constant frame interval, and
the information processing device further comprises:
a second model generator configured to generate a second model by machine learning based on information indicating whether the link image is selected by a user, a user attribute of the user, and information indicating a length of an applied frame interval, wherein the second model is configured to output, for each length of the frame interval, a second score corresponding to a user attribute related to a probability that the link image is selected by the user; and
a frame interval determining unit configured to acquire the second score of each length of a frame interval by inputting the user attribute of the target user into the second model, and preferentially determine a length of a frame interval having a high second score as a length of the frame interval applied to the link image in the first screen presented to the target user.

6. The information processing device according to claim 5, wherein
the second model includes a parameter for each length of the frame interval, and
the second model generator is configured to:
assign a larger reward value to the length of the frame interval applied to the link image when the link image is selected by the user than in a case where the link image is not selected by the user; and
update the parameter corresponding to the length of the frame interval based on the reward value and a user attribute of the user.

7. The information processing device according to claim 5, wherein
the first model includes a parameter for each content, and
the first model generator is configured to:
assign a larger reward value to each of content displayed as the link image at a time point when the link image is selected and content displayed as the link image before the time point when the link image is selected than in a case where the link image is not selected by the user; and
generate the first model by reinforcement learning that updates the parameter corresponding to each content based on the reward value and a user attribute of the user, and
the reward value is set to a larger value for content displayed as the link image at a time point closer to the time point when the link image is selected.

8. The information processing device according to claim 4, wherein
the display control unit is configured to:
display the first screen and the second screen on a display unit included in a user terminal different from the information processing device; and
transmit an image to be displayed first as the link image among the images of the plurality of non-display content determined by the image determining unit to the user terminal, and then transmit an animation image configured such that the image of each of the plurality of non-display content changes over time to the user terminal.
